(19) United States
(12) Patent Application Publication
(10) Pub. No.: US 2019/0171068 A1
(43) Pub. Date: Jun. 6, 2019

(54) LIQUID CRYSTAL DISPLAY DEVICE

(71) Applicant: SHARP KABUSHIKI KAISHA, Osaka (JP)

(72) Inventors: TAKAYUKI NATSUME, Sakai City (JP); YASUNOBU AKEBI, Sakai City (JP); MASAAKI SAITOH, Sakai City (JP); KENJI FUJITA, Sakai City (JP); MASAOMI KUWABARA, Sakai City (JP)

(21) Appl. No.: 16/205,140

(22) Filed: Nov. 29, 2018

(30) Foreign Application Priority Data
Dec. 1, 2017 (JP) 2017-231943

(51) Int. Cl. G02F 1/13363; G02F 1/1335; G02F 1/1343

(52) U.S. Cl. CPC G02F 1/133634; G02F 1/133528; G02F 1/134363; G02F 2413/05; G02F 2413/11; G02F 2413/14; G02F 2413/02; G02F 2001/133531

(57) ABSTRACT

The liquid crystal display device includes: a first polarizer; a liquid crystal layer containing liquid crystal molecules; and a second polarizer, the liquid crystal molecules being aligned in a plane parallel to surfaces of the first polarizer and the second polarizer, the first polarizer and the second polarizer being disposed such that their absorption axes are perpendicular to each other, the liquid crystal display device including at least one first retardation layer whose principal refractive indexes satisfy a relationship nx=ny>nz or at least one second retardation layer whose principal refractive indexes satisfy a relationship nx=ny<nz between the first polarizer and the liquid crystal layer or between the second polarizer and the liquid crystal layer, the at least one first retardation layer and the at least one second retardation layer satisfying a predetermined relationship.

### CROSS-REFERENCE TO RELATED APPLICATIONS

The present application claims priority under 35 U.S.C. § 119 to Japanese Patent Application No. 2017-231943 filed on Dec. 1, 2017, the contents of which are incorporated herein by reference in their entirety.

### BACKGROUND OF THE INVENTION

### Field of the Invention

The present invention relates to liquid crystal display devices. More specifically, the present invention relates to a transverse electric field mode liquid crystal display device.

### Description of Related Art

Liquid crystal display devices have been used in applications such as televisions, smartphones, tablet PCs, and car navigation systems. Liquid crystal display devices are desired to have various properties in these applications, and thus a variety of display modes has been studied (for example, see JP 2003-337336 A).

### BRIEF SUMMARY OF THE INVENTION

Some liquid crystal display devices are in a transverse electric field mode such as the in-plane switching (IPS) mode or the fringe field switching (FFS) mode, to achieve a wide viewing angle (favorable viewing angle characteristics). However, such a wide viewing angle is not always preferred for liquid crystal display devices displaying personal information, such as automated teller machines (ATMs) at financial institutions and personal information terminals, because identity theft can occur when displayed contents are visible to others around the device. Rather, the viewing angle of such devices is desired to be narrow.

In response to the above issue, an object of the present invention is to provide a transverse electric field mode liquid crystal display device having a narrow viewing angle.

The present inventors made various studies on a transverse electric field mode liquid crystal display device having a narrow viewing angle. The studies found that when a retardation layer whose principal refractive indexes satisfy a predetermined relationship and whose thickness direction retardation falls within a predetermined range is disposed between a polarizer and a liquid crystal layer in a transverse electric field mode liquid crystal display device, the visibility from an oblique direction decreases while the visibility from the front direction remains high, meaning that the viewing angle becomes narrow. Thereby, the inventors successfully achieved the above object, completing the present invention.

In other words, one aspect of the present invention may be a liquid crystal display device including, in the following order from a back surface side to a viewing surface side: a first polarizer; a liquid crystal layer containing liquid crystal molecules; and a second polarizer, the liquid crystal display device being in a transverse electric field mode, the liquid crystal molecules being aligned in a plane parallel to surfaces of the first polarizer and the second polarizer, the first polarizer and the second polarizer being disposed such that their absorption axes are perpendicular to each other, the liquid crystal display device including at least one first retardation layer whose principal refractive indexes satisfy a relationship nx=ny>nz or at least one second retardation layer whose principal refractive indexes satisfy a relationship nx=ny<nz between the first polarizer and the liquid crystal layer or between the second polarizer and the liquid crystal layer, the at least one first retardation layer and the at least one second retardation layer satisfying: (1) a relationship where the at least one first retardation layer, in the case of being disposed between the first polarizer and the liquid crystal layer, has a total thickness direction retardation Rth of 300 to 900 nm; (2) a relationship where the at least one second retardation layer, in the case of being disposed between the first polarizer and the liquid crystal layer, has a total thickness direction retardation Rth of −800 to −120 nm; (3) a relationship where the at least one first retardation layer, in the case of being disposed between the second polarizer and the liquid crystal layer, has a total thickness direction retardation Rth of 200 to 1000 nm; or (4) a relationship where the at least one second retardation layer, in the case of being disposed between the second polarizer and the liquid crystal layer, has a total thickness direction retardation Rth of −1100 to −200 nm, wherein, in the at least one first retardation layer and the at least one second retardation layer, nx and ny each represent a principal refractive index in an in-plane direction, nz represents a principal refractive index in a thickness direction, and a thickness direction retardation Rth equals to ((nx+ny)/2−nz)×D, where D represents a thickness.

The present invention can provide a transverse electric field mode liquid crystal display device having a narrow viewing angle.

### BRIEF DESCRIPTION OF THE DRAWINGS

FIG. 1 is a schematic cross-sectional view of a liquid crystal display device of Embodiment 1.

FIGS. 2A and 2B are schematic cross-sectional views for describing an exemplary method for forming a first retardation layer.

FIG. 3 is a schematic cross-sectional view of a liquid crystal display device of a modified example of Embodiment 1.

FIG. 4 is a schematic cross-sectional view of a liquid crystal display device of Embodiment 2.

FIGS. 5A, 5B, and 5C are schematic cross-sectional views for describing an exemplary method for forming a second retardation layer.

FIG. 6 is a schematic cross-sectional view of a liquid crystal display device of a modified example of Embodiment 2.

FIG. 7 is a schematic cross-sectional view of a liquid crystal display device of Embodiment 3.

FIG. 8 is a schematic cross-sectional view of a liquid crystal display device of a modified example of Embodiment 3.

FIG. 9 is a schematic cross-sectional view of a liquid crystal display device of Embodiment 4.

FIG. 10 is a schematic cross-sectional view of a liquid crystal display device of a modified example of Embodiment 4.

FIG. 11 is a graph showing the relationship between the thickness direction retardation Rth and the front contrast ratio in the first retardation layer and the second retardation layer.

FIG. 12 is a graph showing the relationship between the thickness direction retardation Rth and the oblique contrast ratio in the first retardation layer and the second retardation layer.

### DETAILED DESCRIPTION OF THE INVENTION

The present invention is described in more detail below based on embodiments with reference to the drawings. The embodiments, however, are not intended to limit the scope of the present invention. The structures in the embodiments may appropriately be combined or modified within the spirit of the present invention.

The expression “X to Y” as used herein means “X or more and Y or less”.

### Embodiment 1

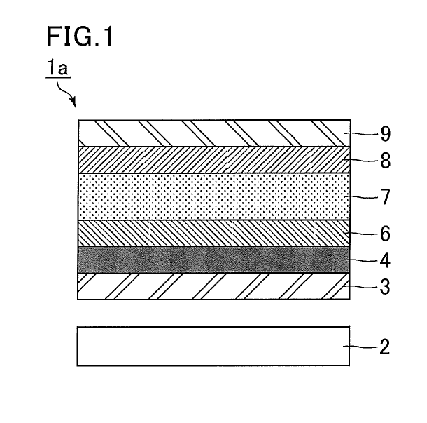

A liquid crystal display device of Embodiment 1 is described below with reference to FIG. 1. FIG. 1 is a schematic cross-sectional view of the liquid crystal display device of Embodiment 1.

A liquid crystal display device 1a includes, in the following order from the back surface side to the viewing surface side, a backlight 2, a first polarizer 3, a first retardation layer 4, a first substrate 6, a liquid crystal layer 7, a second substrate 8, and a second polarizer 9. The liquid crystal layer 7 is sandwiched between the first substrate 6 and the second substrate 8, which are bonded to each other with a sealant. The liquid crystal display device 1a is a transverse electric field mode (transmissive) liquid crystal display device. The “back surface side” as used herein means the side farther from the screen (display surface) of the liquid crystal display device; for example, the back surface side in FIG. 1 means the lower side (backlight 2 side) of the liquid crystal display device 1a. The “viewing surface side” as used herein means the side closer to the screen (display surface) of the liquid crystal display device; for example, the viewing surface side in FIG. 1 means the upper side (second polarizer 9 side) of the liquid crystal display device 1a.

### <Backlight>

The backlight 2 can be a conventionally known one. The backlight 2 may be of any type such as an edge-lit backlight or a direct-lit backlight. The backlight 2 may include any light source such as a light emitting diode (LED) or a cold cathode fluorescent lamp (CCFL).

### <First Polarizer and Second Polarizer>

The first polarizer 3 and the second polarizer 9 may be, for example, one obtained by dyeing a polyvinyl alcohol film with an anisotropic material such as an iodine complex (or dye) to adsorb the anisotropic material on the polyvinyl alcohol film, and stretching the film for alignment. A polarizer herein means a linear polarizer (absorptive polarizer), which is different from a circular polarizer.

The first polarizer 3 and the second polarizer 9 are disposed such that their absorption axes are perpendicular to each other. This means that the first polarizer 3 and the second polarizer 9 are disposed in crossed Nicols, allowing the liquid crystal display device to provide black display with no voltage applied to the liquid crystal layer 7 and to provide grayscale display (e.g., intermediate grayscale display, white display) with voltage applied to the liquid crystal layer 7. The expression “two axes are perpendicular to each other” herein means that the axes form an angle of 87° to 93°, preferably 89° to 91°, more preferably 89.5° to 90.5°, particularly preferably 90° (perfect right angle).

### <First Retardation Layer>

The first retardation layer 4 is a uniaxial retardation layer whose principal refractive indexes satisfy the relationship nx=ny>nz, i.e., a negative C plate.

The first retardation layer 4 has a thickness direction retardation Rth of 300 to 900 nm, preferably 400 to 900 nm. In the present embodiment, the first retardation layer 4 having a thickness direction retardation Rth falling within the above range is disposed between the first polarizer 3 and the liquid crystal layer 7. This increases the viewing angle dependence due to the birefringence of the liquid crystal molecules in the liquid crystal layer 7 with respect to light emitted from the backlight 2 toward the viewing surface side. Thereby, the visibility from an oblique direction decreases while the visibility from the front direction remains high, i.e., the viewing angle becomes narrow.

Herein, nx and ny each represent a principal refractive index in an in-plane direction of the retardation layer, and nz represents a principal refractive index in the thickness direction of the retardation layer. Each principal refractive index indicates a value measured with light having a wavelength of 550 nm, unless otherwise specified. The thickness direction retardation Rth of the retardation layer is calculated from Rth=((nx+ny)/2−nz)×D where D represents the thickness of the retardation layer.

The first retardation layer 4 can be, for example, a stretched polymer film. The polymer film may be formed of, for example, a cycloolefin polymer, polycarbonate, polysulfone, polyethersulfone, polyethylene terephthalate, polyethylene, polyvinyl alcohol, norbornene, triacetyl cellulose, or diacetyl cellulose. Preferred among these is a cycloolefin polymer. A cycloolefin polymer can give a retardation layer that has excellent durability and is likely to introduce a constant retardation even when exposed to a harsh environment such as a high-temperature environment or a high-temperature, high-humidity environment for a long period of time.

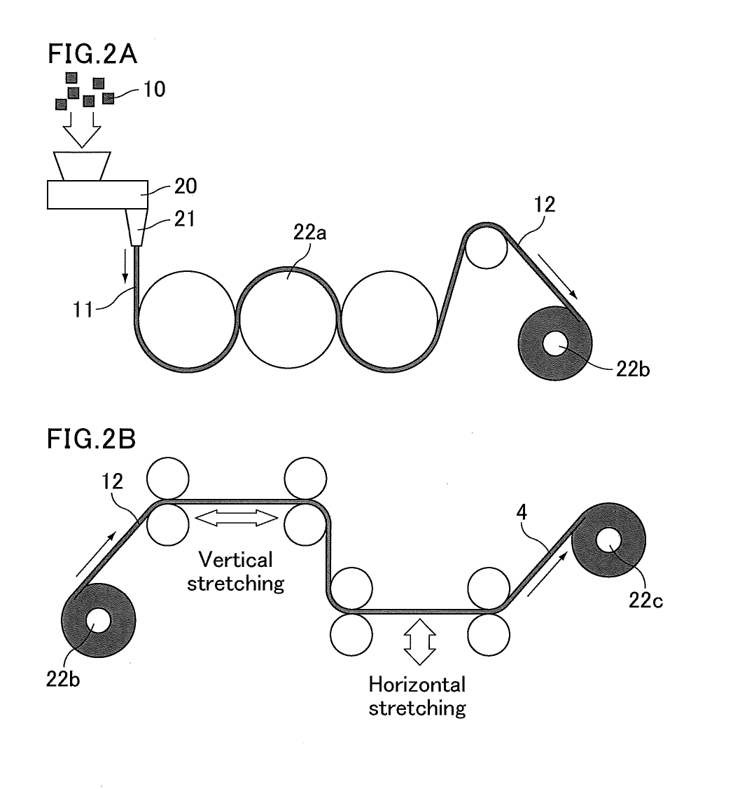

An exemplary method for forming a stretched polymer film to be used as the first retardation layer 4 is described below with reference to FIGS. 2A and 2B. FIGS. 2A and 2B are schematic cross-sectional views for describing an exemplary method for forming a first retardation layer.

As shown in FIG. 2A, polymer resin pellets 10, which are a raw material, are fed into a melting furnace 20 and melted. A molten polymer resin 11 is ejected from a die head 21 and cooled on some rollers 22a, whereby a polymer film 12 is formed. The polymer film 12 is then wound around a roller 22b.

As shown in FIG. 2B, the polymer film 12 unwound from the roller 22b is vertically stretched (stretched in the direction parallel to the machine direction of the polymer film 12) while being heated, and then horizontally stretched (stretched in the direction perpendicular to the machine direction of the polymer film 12) while being heated, i.e., the polymer film 12 is subjected to sequential biaxial stretching, so that the first retardation layer 4 is formed. The first retardation layer 4 is wound around a roller 22c. The conditions of the sequential biaxial stretching may be adjusted such that the principal refractive indexes satisfy the relationship nx=ny>nz. The thickness direction retardation Rth of the first retardation layer 4 is adjusted by adjusting the principal refractive indexes nx, ny, and nz, which are adjustable in adjusting the conditions of the sequential biaxial stretching, and the thickness D of the first retardation layer 4.

In the present embodiment, the first retardation layer 4 is disposed between the first polarizer 3 and the liquid crystal layer 7. Meanwhile, for a narrow viewing angle, substantially no retardation layer is preferably disposed between the second polarizer 9 and the liquid crystal layer 7. In the present embodiment, the expression “substantially no retardation layer is disposed” means that at least one retardation layer having a total thickness direction retardation Rth of 50 nm or more is not disposed.

### <First Substrate>

The first substrate 6 may be, for example, a transparent substrate such as a glass substrate or a plastic substrate. On the liquid crystal layer 7 side of the first substrate 6 may appropriately be disposed members such as gate lines, source lines, thin-film transistor elements, and electrodes, for example. The members can be those formed of conventionally known materials.

In the case where the liquid crystal display device 1a is in the IPS mode, for example, the electrodes disposed on the liquid crystal layer 7 side of the first substrate 6 are a pair of comb electrodes. In this case, voltage application between the comb electrodes generates transverse electric fields in the liquid crystal layer 7, controlling the alignment of liquid crystal molecules in the liquid crystal layer 7.

In the case where the liquid crystal display device 1a is in the FFS mode, for example, the electrodes disposed on the liquid crystal layer 7 side of the first substrate 6 are a planar common electrode and pixel electrodes that are disposed on the liquid crystal layer 7 side of the common electrode with an insulating layer in between and are each provided with slits. In this case, voltage application between the common electrode and the pixel electrodes generates transverse electric fields (fringe electric fields) in the liquid crystal layer 7, controlling the alignment of liquid crystal molecules in the liquid crystal layer 7.

Between the first substrate 6 and the liquid crystal layer 7 may be disposed a horizontal alignment film. The horizontal alignment film can be a conventionally known one.

### <Second Substrate>

The second substrate 8 may be, for example, a transparent substrate such as a glass substrate or a plastic substrate. On the liquid crystal layer 7 side of the second substrate 8 may appropriately be disposed members such as a color filter layer, a black matrix, and an overcoat layer, for example. The members can be those formed of conventionally known materials.

Between the second substrate 8 and the liquid crystal layer 7 may be disposed a horizontal alignment film. The horizontal alignment film can be a conventionally known one.

### <Liquid Crystal Layer>

Liquid crystal molecules in the liquid crystal layer 7 are aligned in a plane parallel to the surfaces of the first polarizer 3 and the second polarizer 9. The expression that liquid crystal molecules are aligned in a plane parallel to the surfaces of the first polarizer 3 and the second polarizer 9 means that the tilt angle (including the pre-tilt angle) of the liquid crystal molecules is 0° to 5°, preferably 0° to 3°, more preferably 0° to 1°, from the surfaces of the first polarizer 3 and the second polarizer 9 (in the present embodiment, substantially the surfaces of the first substrate 6 and the second substrate 8). The tilt angle of the liquid crystal molecules means the angle at which the major axis (optical axis) of each liquid crystal molecule is tilted from the surfaces of the first polarizer 3 and the second polarizer 9.

More specifically, the liquid crystal molecules are aligned in the direction parallel to the absorption axis of the first polarizer 3 or the absorption axis of the second polarizer 9 in a plane parallel to the surfaces of the first polarizer 3 and the second polarizer 9 when no voltage is applied to the liquid crystal layer 7. The expression that the liquid crystal molecules are aligned in the direction parallel to the absorption axis of the first polarizer 3 or the absorption axis of the second polarizer 9 means that the major axis (optical axis) of each liquid crystal molecule projected on the surface of the first polarizer 3 or the second polarizer 9 and the absorption axis of the first polarizer 3 or the absorption axis of the second polarizer 9 form an angle of 0° to 3°, preferably 0° to 1°, more preferably 0° to 0.5°, particularly preferably 0° (they are perfectly parallel). The liquid crystal molecules rotate in a plane parallel to the surfaces of the first polarizer 3 and the second polarizer 9 according to the transverse electric fields generated in the liquid crystal layer 7 when voltage is applied to the liquid crystal layer 7.

The liquid crystal layer 7 may be formed of a positive liquid crystal material having positive anisotropy of dielectric constant (Δε>0) or a negative liquid crystal material having negative anisotropy of dielectric constant (Δε<0). For achievement of a narrow viewing angle, the liquid crystal layer 7 preferably introduces a retardation of 280 to 370 nm. The retardation introduced by the liquid crystal layer 7 refers to the maximum effective retardation introduced by the liquid crystal layer 7, which is represented by Δn×d where Δn is the refractive index anisotropy of the liquid crystal layer 7 and d is the thickness of the liquid crystal layer 7. The refractive index anisotropy is a value measured with light having a wavelength of 550 nm, unless otherwise specified.

The liquid crystal display device 1a may further include, as well as the members described above, members usually used in the field of liquid crystal display devices. For example, the liquid crystal display device 1a may appropriately include members such as external circuits, including a tape-carrier package (TCP) and a printed circuit board (PCB); and a bezel (frame).

The liquid crystal display device 1a has a narrow viewing angle and is thus suitable for application where identity theft, which can be caused when displayed contents are visible to others around the device, needs to be prevented. From this viewpoint, the liquid crystal display device 1a is useful as, for example, a liquid crystal display device displaying personal information, such as an ATM at a financial institution or a personal information terminal.

The first retardation layer 4 in the present embodiment is disposed between the first polarizer 3 and the liquid crystal layer 7, particularly between the first polarizer 3 and the first substrate 6, as an out-cell member. Yet, the first retardation layer 4 may be disposed between the first substrate 6 and the liquid crystal layer 7 as an in-cell member in a modified example.

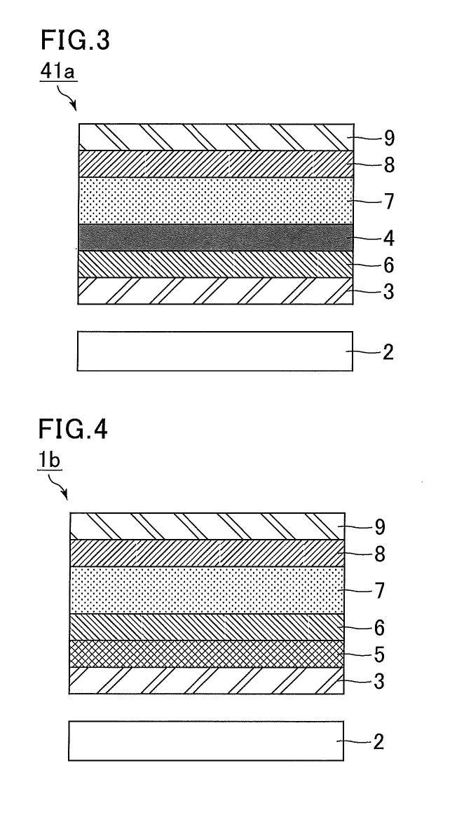

FIG. 3 is a schematic cross-sectional view of a liquid crystal display device of a modified example of Embodiment 1. As shown in FIG. 3, a liquid crystal display device 41a includes, in the following order from the back surface side to the viewing surface side, the backlight 2, the first polarizer 3, the first substrate 6, the first retardation layer 4, the liquid crystal layer 7, the second substrate 8, and the second polarizer 9. On the liquid crystal layer 7 side of the first substrate 6 may appropriately be disposed members such as gate lines, source lines, thin-film transistor elements, and electrodes. These members may be disposed between the first substrate 6 and the first retardation layer 4 or between the first retardation layer 4 and the liquid crystal layer 7.

In the present embodiment and the modified example thereof, one or a plurality of the first retardation layers 4 may be disposed between the first polarizer 3 and the liquid crystal layer 7. In the case where a plurality of the first retardation layers 4 is disposed between the first polarizer 3 and the liquid crystal layer 7, the total thickness direction retardation Rth of the first retardation layers 4 may only have to be 300 to 900 nm, preferably 400 to 900 nm. In this case, all the first retardation layers 4 may be disposed between the first polarizer 3 and the first substrate 6 or between the first substrate 6 and the liquid crystal layer 7, or the first retardation layers 4 may be divided into two groups, and one group may be disposed between the first polarizer 3 and the first substrate 6 and the other group between the first substrate 6 and the liquid crystal layer 7.

### Embodiment 2

A liquid crystal display device of Embodiment 2 is described below with reference to FIG. 4. FIG. 4 is a schematic cross-sectional view of the liquid crystal display device of Embodiment 2. The liquid crystal display device of Embodiment 2 is the same as the liquid crystal display device of Embodiment 1 except that a second retardation layer is disposed instead of the first retardation layer. Thus, the same points will not be described.

A liquid crystal display device 1b includes, in the following order from the back surface side to the viewing surface side, the backlight 2, the first polarizer 3, a second retardation layer 5, the first substrate 6, the liquid crystal layer 7, the second substrate 8, and the second polarizer 9.

### <Second Retardation Layer>

The second retardation layer 5 is a uniaxial retardation layer whose principal refractive indexes satisfy the relationship nx=ny<nz, i.e., a positive C plate.

The second retardation layer 5 has a thickness direction retardation Rth of −800 to −120 nm, preferably −750 to −220 nm. In the present embodiment, the second retardation layer 5 having a thickness direction retardation Rth falling within the above range is disposed between the first polarizer 3 and the liquid crystal layer 7. This increases the viewing angle dependence due to the birefringence of the liquid crystal molecules in the liquid crystal layer 7 with respect to light emitted from the backlight 2 toward the viewing surface side. Thereby, the visibility from an oblique direction decreases while the visibility from the front direction remains high, i.e., the viewing angle becomes narrow.

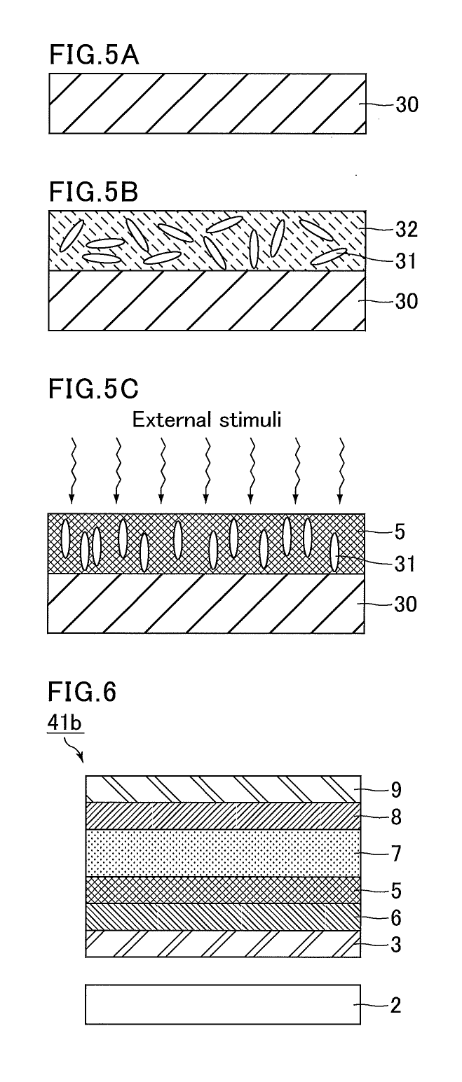

The second retardation layer 5 may be formed of, for example, rod-like liquid crystal compounds. An exemplary method for forming the second retardation layer 5 containing rod-like liquid crystal compounds is described below with reference to FIGS. 5A, 5B, and 5C. FIGS. 5A, 5B, and 5C are schematic cross-sectional views for describing an exemplary method for forming a second retardation layer.

As shown in FIG. 5A, a substrate 30 is prepared. The substrate 30 may be, for example, a polymer film such as an acrylic film, a cycloolefin polymer film, or a polyethylene terephthalate film.

As shown in FIG. 5B, a coating material containing rod-like liquid crystal compounds 31 is applied to a surface of the substrate 30 to form a coating film 32. The coating material containing the rod-like liquid crystal compounds 31 may contain a solvent.

As shown in FIG. 5C, external stimuli such as electromagnetic waves (e.g., light, magnetic waves) or heat are given to the coating film 32, so that the optical axes of the rod-like liquid crystal compounds 31 are aligned in the thickness direction of the coating film 32 and fixed in this state. Thereby, the second retardation layer 5 is formed. The thickness direction retardation Rth of the second retardation layer 5 is adjusted by adjusting the principal refractive indexes nx, ny, and nz, which are adjustable in adjusting the molecular structure, blending amount, and degree of alignment of the rod-like liquid crystal compounds 31, and the thickness D of the second retardation layer 5.

In the case where the substrate 30 is a substrate having three-dimensionally isotropic refractive indexes (for example, unstretched polymer film), the second retardation layer 5 used may be a stack of the second retardation layer 5 on the substrate 30. In contrast, in the case where the substrate 30 is a substrate having three-dimensionally unisotropic refractive indexes (for example, biaxially stretched polymer film), the second retardation layer 5 used may be one transferred to a substrate having three-dimensionally isotropic refractive indexes.

In the present embodiment, the second retardation layer 5 is disposed between the first polarizer 3 and the liquid crystal layer 7. Meanwhile, for a narrow viewing angle, substantially no retardation layer is preferably disposed between the second polarizer 9 and the liquid crystal layer 7. In the present embodiment, the expression “substantially no retardation layer is disposed” means that at least one retardation layer having a total thickness direction retardation Rth of 50 nm or more is not disposed.

The second retardation layer 5 in the present embodiment is disposed between the first polarizer 3 and the liquid crystal layer 7, particularly between the first polarizer 3 and the first substrate 6, as an out-cell member. Yet, the second retardation layer 5 may be disposed between the first substrate 6 and the liquid crystal layer 7 as an in-cell member in a modified example.

FIG. 6 is a schematic cross-sectional view of a liquid crystal display device of a modified example of Embodiment 2. As shown in FIG. 6, a liquid crystal display device 41b includes, in the following order from the back surface side to the viewing surface side, the backlight 2, the first polarizer 3, the first substrate 6, the second retardation layer 5, the liquid crystal layer 7, the second substrate 8, and the second polarizer 9. On the liquid crystal layer 7 side of the first substrate 6 may appropriately be disposed members such as gate lines, source lines, thin-film transistor elements, and electrodes. These members may be disposed between the first substrate 6 and the second retardation layer 5 or between the second retardation layer 5 and the liquid crystal layer 7.

In the present embodiment and the modified example thereof, one or a plurality of the second retardation layers 5 may be disposed between the first polarizer 3 and the liquid crystal layer 7. In the case where a plurality of the second retardation layers 5 is disposed between the first polarizer 3 and the liquid crystal layer 7, the total thickness direction retardation Rth of the second retardation layers 5 may only have to be −800 to −120 nm, preferably −750 to −220 nm. In this case, all the second retardation layers 5 may be disposed between the first polarizer 3 and the first substrate 6 or between the first substrate 6 and the liquid crystal layer 7, or the second retardation layers 5 may be divided into two groups, and one group may be disposed between the first polarizer 3 and the first substrate 6 and the other group between the first substrate 6 and the liquid crystal layer 7.

### Embodiment 3

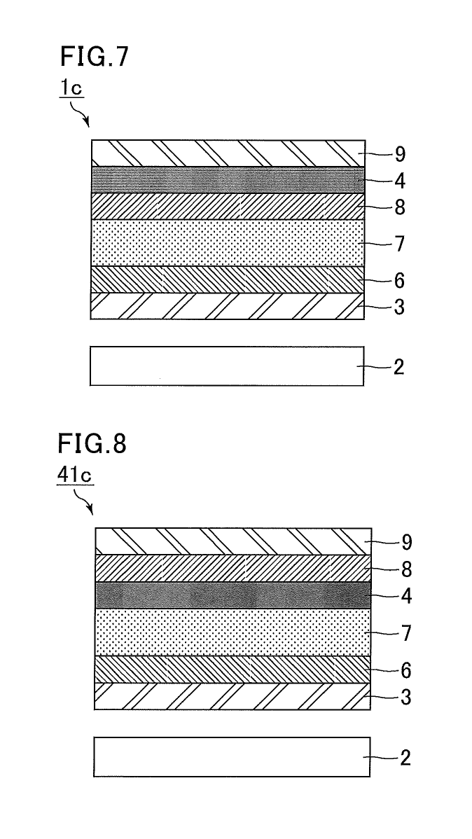

A liquid crystal display device of Embodiment 3 is described below with reference to FIG. 7. FIG. 7 is a schematic cross-sectional view of the liquid crystal display device of Embodiment 3. The liquid crystal display device of Embodiment 3 is the same as the liquid crystal display device of Embodiment 1 except that the first retardation layer is disposed at a different position. Thus, the same points will not be described.

A liquid crystal display device 1c includes, in the following order from the back surface side to the viewing surface side, the backlight 2, the first polarizer 3, the first substrate 6, the liquid crystal layer 7, the second substrate 8, the first retardation layer 4, and the second polarizer 9.

The first retardation layer 4 has a thickness direction retardation Rth of 200 to 1000 nm, preferably 250 to 900 nm. In the present embodiment, the first retardation layer 4 having a thickness direction retardation Rth falling within the above range is disposed between the second polarizer 9 and the liquid crystal layer 7. This increases the viewing angle dependence due to the birefringence of the liquid crystal molecules in the liquid crystal layer 7 with respect to light emitted from the backlight 2 toward the viewing surface side. Thereby, the visibility from an oblique direction decreases while the visibility from the front direction remains high, i.e., the viewing angle becomes narrow.

In the present embodiment, the first retardation layer 4 is disposed between the second polarizer 9 and the liquid crystal layer 7. Meanwhile, for a narrow viewing angle, substantially no retardation layer is preferably disposed between the first polarizer 3 and the liquid crystal layer 7. In the present embodiment, the expression “substantially no retardation layer is disposed” means that at least one retardation layer having a total thickness direction retardation Rth of 50 nm or more is not disposed.

The first retardation layer 4 in the present embodiment is disposed between the second polarizer 9 and the liquid crystal layer 7, particularly between the second polarizer 9 and the second substrate 8, as an out-cell member. Yet, the first retardation layer 4 may be disposed between the second substrate 8 and the liquid crystal layer 7 as an in-cell member in a modified example.

FIG. 8 is a schematic cross-sectional view of a liquid crystal display device of a modified example of Embodiment 3. As shown in FIG. 8, a liquid crystal display device 41c includes, in the following order from the back surface side to the viewing surface side, the backlight 2, the first polarizer 3, the first substrate 6, the liquid crystal layer 7, the first retardation layer 4, the second substrate 8, and the second polarizer 9. On the liquid crystal layer 7 side of the second substrate 8 may appropriately be disposed members such as a color filter layer, a black matrix, and an overcoat layer. These members may be disposed between the second substrate 8 and the first retardation layer 4 or between the first retardation layer 4 and the liquid crystal layer 7.

In the present embodiment and the modified example thereof, one or a plurality of the first retardation layers 4 may be disposed between the second polarizer 9 and the liquid crystal layer 7. In the case where a plurality of the first retardation layers 4 is disposed between the second polarizer 9 and the liquid crystal layer 7, the total thickness direction retardation Rth of the first retardation layers 4 may only have to be 200 to 1000 nm, preferably 250 to 900 nm. In this case, all the first retardation layers 4 may be disposed between the second polarizer 9 and the second substrate 8 or between the second substrate 8 and the liquid crystal layer 7, or the first retardation layers 4 may be divided into two groups, and one group may be disposed between the second polarizer 9 and the second substrate 8 and the other group between the second substrate 8 and the liquid crystal layer 7.

### Embodiment 4

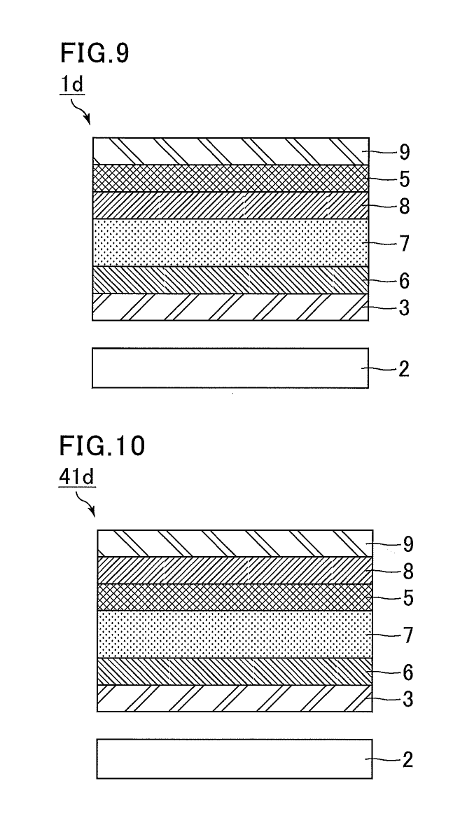

A liquid crystal display device of Embodiment 4 is described below with reference to FIG. 9. FIG. 9 is a schematic cross-sectional view of the liquid crystal display device of Embodiment 4. The liquid crystal display device of Embodiment 4 is the same as the liquid crystal display device of Embodiment 2 except that the second retardation layer is disposed at a different position. Thus, the same points will not be described.

A liquid crystal display device 1d includes, in the following order from the back surface side to the viewing surface side, the backlight 2, the first polarizer 3, the first substrate 6, the liquid crystal layer 7, the second substrate 8, the second retardation layer 5, and the second polarizer 9.

The second retardation layer 5 has a thickness direction retardation Rth of −1100 to −200 nm, preferably −900 to −300 nm. In the present embodiment, the second retardation layer 5 having a thickness direction retardation Rth falling within the above range is disposed between the second polarizer 9 and the liquid crystal layer 7. This increases the viewing angle dependence due to the birefringence of the liquid crystal molecules in the liquid crystal layer 7 with respect to light emitted from the backlight 2 toward the viewing surface side. Thereby, the visibility from an oblique direction decreases while the visibility from the front direction remains high, i.e., the viewing angle becomes narrow.

In the present embodiment, the second retardation layer 5 is disposed between the second polarizer 9 and the liquid crystal layer 7. Meanwhile, for a narrow viewing angle, substantially no retardation layer is preferably disposed between the first polarizer 3 and the liquid crystal layer 7. In the present embodiment, the expression “substantially no retardation layer is disposed” means that at least one retardation layer having a total thickness direction retardation Rth of 50 nm or more is not disposed.

The second retardation layer 5 in the present embodiment is disposed between the second polarizer 9 and the liquid crystal layer 7, particularly between the second polarizer 9 and the second substrate 8, as an out-cell member. Yet, the second retardation layer 5 may be disposed between the second substrate 8 and the liquid crystal layer 7 as an in-cell member in a modified example.

FIG. 10 is a schematic cross-sectional view of a liquid crystal display device of a modified example of Embodiment 4. As shown in FIG. 10, a liquid crystal display device 41d includes, in the following order from the back surface side to the viewing surface side, the backlight 2, the first polarizer 3, the first substrate 6, the liquid crystal layer 7, the second retardation layer 5, the second substrate 8, and the second polarizer 9. On the liquid crystal layer 7 side of the second substrate 8 may appropriately be disposed members such as a color filter layer, a black matrix, and an overcoat layer. These members may be disposed between the second substrate 8 and the second retardation layer 5 or between the second retardation layer 5 and the liquid crystal layer 7.

In the present embodiment and the modified example thereof, one or a plurality of the second retardation layers 5 may be disposed between the second polarizer 9 and the liquid crystal layer 7. In the case where a plurality of the second retardation layers 5 is disposed between the second polarizer 9 and the liquid crystal layer 7, the total thickness direction retardation Rth of the second retardation layers 5 may only have to be −1100 to −200 nm, preferably −900 to −300 nm. In this case, all the second retardation layers 5 may be disposed between the second polarizer 9 and the second substrate 8 or between the second substrate 8 and the liquid crystal layer 7, or the second retardation layers 5 may be divided into two groups, and one group may be disposed between the second polarizer 9 and the second substrate 8 and the other group between the second substrate 8 and the liquid crystal layer 7.

### EXAMPLES AND COMPARATIVE EXAMPLES

The present invention is described in more detail based on examples and comparative examples. The examples, however, are not intended to limit the scope of the present invention.

### Example 1

The liquid crystal display device of Embodiment 1 was produced as a liquid crystal display device of Example 1. The liquid crystal display device of Example 1 included the following members. The first polarizer and the first retardation layer were bonded to each other with a transparent adhesive. The first retardation layer and the first substrate were bonded to each other with a transparent adhesive. The second substrate and the second polarizer were bonded to each other with a transparent adhesive.

### <First Polarizer>

The first polarizer used was one (absorptive polarizer) obtained by dyeing a polyvinyl alcohol film with an iodine complex (or dye) to adsorb the iodine complex on the polyvinyl alcohol film, and stretching the film for alignment.

### <First Retardation Layer>

The first retardation layer used was one formed by the following method. A stretched cycloolefin polymer film (negative C plate) was formed by the method described with reference to FIGS. 2A and 2B. The specifications thereof were as follows.
Thickness D: 20000 nm
Principal refractive index nx: 1.501
Principal refractive index ny: 1.501
Principal refractive index nz: 1.496
Thickness direction retardation Rth: 100 nm

Three of these films were obtained, and the films were stacked with a colorless and transparent adhesive film having a three-dimensionally isotropic refractive index (1.47) in between. Thereby, a retardation layer (stack of negative C plates) having a thickness direction retardation Rth of 300 nm was obtained.

### <First Substrate>

The first substrate used was one (thin-film transistor array substrate) obtained by disposing an electrode structure for the IPS mode on a surface of a glass substrate.

### <Liquid Crystal Layer>

The liquid crystal layer used was one containing a positive liquid crystal material (anisotropy of dielectric constant Δε: 2.5). The specifications thereof were as follows.
Thickness d: 3000 nm
Refractive index anisotropy Δn: 0.11
Retardation: 330 nm

### <Second Substrate>

The second substrate used was one (color filter substrate) obtained by disposing a color filter structure for the IPS mode on a surface of a glass substrate.

### <Second Polarizer>

The second polarizer used was one (absorptive polarizer) obtained by dyeing a polyvinyl alcohol film with an iodine complex (or dye) to adsorb the iodine complex on the polyvinyl alcohol film, and stretching the film for alignment.

### Example 2

A liquid crystal display device of Example 2 was the same as the liquid crystal display device of Example 1, except that the specifications of the first retardation layer were different.

### <First Retardation Layer>

The first retardation layer used was one formed by the following method. A stretched cycloolefin polymer film (negative C plate) was formed by the method described with reference to FIGS. 2A and 2B. The specifications thereof were as follows.
Thickness D: 50000 nm
Principal refractive index nx: 1.5015
Principal refractive index ny: 1.5015
Principal refractive index nz: 1.496
Thickness direction retardation Rth: 275 nm

Two of these films were obtained, and the films were stacked with a colorless and transparent adhesive film having a three-dimensionally isotropic refractive index (1.47) in between. Thereby, a retardation layer (stack of negative C plates) having a thickness direction retardation Rth of 550 nm was obtained.

### Example 3

A liquid crystal display device of Example 3 was the same as the liquid crystal display device of Example 1, except that the specifications of the first retardation layer were different.

### <First Retardation Layer>

The first retardation layer used was one formed by the following method. A stretched cycloolefin polymer film (negative C plate) was formed by the method described with reference to FIGS. 2A and 2B. The specifications thereof were as follows.
Thickness D: 45000 nm
Principal refractive index nx: 1.501
Principal refractive index ny: 1.501
Principal refractive index nz: 1.496
Thickness direction retardation Rth: 225 nm

Four of these films were obtained, and the films were stacked with a colorless and transparent adhesive film having a three-dimensionally isotropic refractive index (1.47) in between. Thereby, a retardation layer (stack of negative C plates) having a thickness direction retardation Rth of 900 nm was obtained.

### Comparative Example 1

A liquid crystal display device of Comparative Example 1 was the same as the liquid crystal display device of Example 1, except that the specifications of the first retardation layer were different.

### <First Retardation Layer>

The first retardation layer used was a stretched cycloolefin polymer film (negative C plate) formed by the method described with reference to FIGS. 2A and 2B. The specifications thereof were as follows.
Thickness D: 50000 nm
Principal refractive index nx: 1.501
Principal refractive index ny: 1.501
Principal refractive index nz: 1.496
Thickness direction retardation Rth: 250 nm

### Comparative Example 2

A liquid crystal display device of Comparative Example 2 was the same as the liquid crystal display device of Example 1, except that the specifications of the first retardation layer were different.

### <First Retardation Layer>

The first retardation layer used was one formed by the following method. A stretched cycloolefin polymer film (negative C plate) was formed by the method described with reference to FIGS. 2A and 2B. The specifications thereof were as follows.
Thickness D: 50000 nm
Principal refractive index nx: 1.501
Principal refractive index ny: 1.501
Principal refractive index nz: 1.496
Thickness direction retardation Rth: 250 nm

Four of these films were obtained, and the films were stacked with a colorless and transparent adhesive film having a three-dimensionally isotropic refractive index (1.47) in between. Thereby, a retardation layer (stack of negative C plates) having a thickness direction retardation Rth of 1000 nm was obtained.

### [Evaluation 1]

The viewing angle characteristics of each of the liquid crystal display devices of Examples 1 to 3 and Comparative Examples 1 and 2 were evaluated by calculating the front contrast ratio and the oblique contrast ratio. The results are shown in Table 1.

### <Front Contrast Ratio>

The front contrast ratio of the liquid crystal display device of each example was calculated by measuring the front luminance in each of the black display state (with no voltage applied) and the white display state (with voltage applied) using CONOSCOPE 80 available from Autronic-Melchers GmbH and substituting the measured values into the following formula (A). In the front luminance measurement, the azimuth angle was measured in one-degree increments from 0° to 90°, and the polar angle was measured in one-degree increments from 0° to 10°.

Front contrast ratio=(front luminance in white display state)/(front luminance in black display state) (A)

A liquid crystal display having a front contrast ratio of 100 or higher was evaluated as having high visibility from the front direction.

### <Oblique Contrast Ratio>

The oblique contrast ratio of the liquid crystal display device of each example was calculated by measuring the oblique luminance in each of the black display state (with no voltage applied) and the white display state (with voltage applied) using CONOSCOPE 80 available from Autronic-Melchers GmbH and substituting the measured values into the following formula (B). In the oblique luminance measurement, the azimuth angle was measured in one-degree increments from 30° to 60°, and the polar angle was measured in one-degree increments from 40° to 80°.

Oblique contrast ratio=(oblique luminance in white display state)/(oblique luminance in black display state) (B)

A liquid crystal display having an oblique contrast ratio of 20 or lower was evaluated as having low visibility from an oblique direction.

A liquid crystal display having a front contrast ratio of 100 or higher and an oblique contrast ratio of 20 or lower was therefore evaluated as having high visibility from the front direction and low visibility from an oblique direction, i.e., having a narrow viewing angle.

TABLE 1

| | Thickness direction | | |
|---|---|---|---|
| | retardation Rth of first | Front contrast | Oblique contrast |
| | retardation layer (nm) | ratio | ratio |
| Example 1 | 300 | 798 | 18 |
| Example 2 | 550 | 389 | 3 |
| Example 3 | 900 | 166 | 5 |
| Comparative | 250 | 907 | 31 |
| Example 1 | | | |
| Comparative | 1000 | 136 | 21 |
| Example 2 | | | |

Table 1 shows that transverse electric field mode liquid crystal display devices having a narrow viewing angle were obtained in Examples 1 to 3. In Comparative Examples 1 and 2, however, the oblique contrast ratio was higher than 20, and thus the visibility from an oblique direction was unfortunately high.

### Example 4

The liquid crystal display device of Embodiment 2 was produced as a liquid crystal display device of Example 4. The liquid crystal display device of Example 4 included the following members. The first polarizer and the second retardation layer were bonded to each other with a transparent adhesive. The second retardation layer and the first substrate were bonded to each other with a transparent adhesive. The second substrate and the second polarizer were bonded to each other with a transparent adhesive.

### <First Polarizer>

The first polarizer used was one obtained by dyeing a polyvinyl alcohol film with an iodine complex (or dye) to adsorb the iodine complex on the polyvinyl alcohol film, and stretching the film for alignment (absorptive polarizer).

### <Second Retardation Layer>

The second retardation layer used was one formed by the following method. A film (positive C plate) was formed by the method described with reference to FIGS. 5A, 5B, and 5C. The specifications thereof were as follows.
Thickness D: 1500 nm
Principal refractive index nx: 1.49
Principal refractive index ny: 1.49
Principal refractive index nz: 1.53
Thickness direction retardation Rth: −60 nm

Two of these films were obtained, and the films were stacked with a colorless and transparent adhesive film having a three-dimensionally isotropic refractive index (1.47) in between. Thereby, a retardation layer (stack of positive C plates) having a thickness direction retardation Rth of −120 nm was obtained.

### <First Substrate>

The first substrate used was one (thin-film transistor array substrate) obtained by disposing an electrode structure for the IPS mode on a surface of a glass substrate.

### <Liquid Crystal Layer>

The liquid crystal layer used was one containing a positive liquid crystal material (anisotropy of dielectric constant Δε: 2.5). The specifications thereof were as follows.
Thickness d: 3000 nm
Refractive index anisotropy Δε: 0.11
Retardation: 330 nm

### <Second Substrate>

The second substrate used was one (color filter substrate) obtained by disposing a color filter structure for the IPS mode on a surface of a glass substrate.

### <Second Polarizer>

The second polarizer used was one obtained by dyeing a polyvinyl alcohol film with an iodine complex (or dye) to adsorb the iodine complex on the polyvinyl alcohol film, and stretching the film for alignment (absorptive polarizer).

### Example 5

A liquid crystal display device of Example 5 was the same as the liquid crystal display device of Example 4, except that the specifications of the second retardation layer were different.

### <Second Retardation Layer>

The second retardation layer used was one formed by the following method. A film (positive C plate) was formed by the method described with reference to FIGS. 5A, 5B, and 5C. The specifications thereof were as follows.
Thickness D: 5000 nm
Principal refractive index nx: 1.49
Principal refractive index ny: 1.49
Principal refractive index nz: 1.545
Thickness direction retardation Rth: −275 nm

Two of these films were obtained, and the films were stacked with a colorless and transparent adhesive film having a three-dimensionally isotropic refractive index (1.47) in between. Thereby, a retardation layer (stack of positive C plates) having a thickness direction retardation Rth of −550 nm was obtained.

### Example 6

A liquid crystal display device of Example 6 was the same as the liquid crystal display device of Example 4, except that the specifications of the second retardation layer were different.

### <Second Retardation Layer>

The second retardation layer used was one formed by the following method. A film (positive C plate) was formed by the method described with reference to FIGS. 5A, 5B, and 5C. The specifications thereof were as follows.
Thickness D: 5000 nm
Principal refractive index nx: 1.49
Principal refractive index ny: 1.49
Principal refractive index nz: 1.53
Thickness direction retardation Rth: −200 nm

Four of these films were obtained, and the films were stacked with a colorless and transparent adhesive film having a three-dimensionally isotropic refractive index (1.47) in between. Thereby, a retardation layer (stack of positive C plates) having a thickness direction retardation Rth of −800 nm was obtained.

### Comparative Example 3

A liquid crystal display device of Comparative Example 3 was the same as the liquid crystal display device of Example 4, except that the specifications of the second retardation layer were different.

### <Second Retardation Layer>

The second retardation layer used was a film (positive C plate) formed by the method described with reference to FIGS. 5A, 5B, and 5C. The specifications thereof were as follows.
Thickness D: 1500 nm
Principal refractive index nx: 1.49
Principal refractive index ny: 1.49
Principal refractive index nz: 1.53
Thickness direction retardation Rth: −60 nm

### Comparative Example 4

A liquid crystal display device of Comparative Example 4 was the same as the liquid crystal display device of Example 4, except that the specifications of the second retardation layer were different.

### <Second Retardation Layer>

The second retardation layer used was one formed by the following method. A film F1 (positive C plate) was formed by the method described with reference to FIGS. 5A, 5B, and 5C. The specifications thereof were as follows.
Thickness D: 5000 nm
Principal refractive index nx: 1.49
Principal refractive index ny: 1.49
Principal refractive index nz: 1.53
Thickness direction retardation Rth: −200 nm

Then, a film F2 (positive C plate) was formed by the method described with reference to FIGS. 5A, 5B, and 5C. The specifications thereof were as follows.
Thickness D: 2500 nm
Principal refractive index nx: 1.49
Principal refractive index ny: 1.49
Principal refractive index nz: 1.53
Thickness direction retardation Rth: −100 nm

Four of the films F1 were obtained, and the films were stacked with a colorless and transparent adhesive film having a three-dimensionally isotropic refractive index (1.47) in between. Also, the film F2 was stacked on the stack of the films F1 with the same colorless and transparent adhesive film in between. Thereby, a retardation layer (stack of positive C plates) having a thickness direction retardation Rth of −900 nm was obtained.

### [Evaluation 2]

The viewing angle characteristics of each of the liquid crystal display devices of Examples 4 to 6 and Comparative Examples 3 and 4 were evaluated by calculating the front contrast ratio and the oblique contrast ratio in the same manner as in Evaluation 1. The results are shown in Table 2.

TABLE 2

| | Thickness direction | | |
|---|---|---|---|
| | retardation Rth of second | Front contrast | Oblique |
| | retardation layer (nm) | ratio | contrast ratio |
| Example 4 | −120 | 847 | 19 |
| Example 5 | −550 | 257 | 2 |
| Example 6 | −800 | 148 | 12 |
| Comparative | −60 | 973 | 36 |
| Example 3 | | | |
| Comparative | −900 | 123 | 151 |
| Example 4 | | | |

Table 2 shows that transverse electric field mode liquid crystal display devices having a narrow viewing angle were obtained in Examples 4 to 6. In Comparative Examples 3 and 4, however, the oblique contrast ratio was higher than 20, and thus the visibility from an oblique direction was unfortunately high.

### Example 7

The liquid crystal display device of Embodiment 3 was produced as a liquid crystal display device of Example 7. The liquid crystal display device of Example 7 included the following members. The first polarizer and the first substrate were bonded to each other with a transparent adhesive. The second substrate and the first retardation layer were bonded to each other with a transparent adhesive. The first retardation layer and the second polarizer were bonded to each other with a transparent adhesive.

### <First Polarizer>

The first polarizer used was one obtained by dyeing a polyvinyl alcohol film with an iodine complex (or dye) to adsorb the iodine complex on the polyvinyl alcohol film, and stretching the film for alignment (absorptive polarizer).

### <First Substrate>

The first substrate used was one (thin-film transistor array substrate) obtained by disposing an electrode structure for the IPS mode on a surface of a glass substrate.

### <Liquid Crystal Layer>

The liquid crystal layer used was one containing a positive liquid crystal material (anisotropy of dielectric constant Δε: 2.5). The specifications thereof were as follows.
Thickness d: 3000 nm
Refractive index anisotropy Δn: 0.11
Retardation: 330 nm

### <Second Substrate>

The second substrate used was one (color filter substrate) obtained by disposing a color filter structure for the IPS mode on a surface of a glass substrate.

### <First Retardation Layer>

The first retardation layer used was one formed by the following method. A stretched cycloolefin polymer film (negative C plate) was formed by the method described with reference to FIGS. 2A and 2B. The specifications thereof were as follows.
Thickness D: 20000 nm
Principal refractive index nx: 1.501
Principal refractive index ny: 1.501
Principal refractive index nz: 1.496
Thickness direction retardation Rth: 100 nm

Two of these films were obtained, and the films were stacked with a colorless and transparent adhesive film having a three-dimensionally isotropic refractive index (1.47) in between. Thereby, a retardation layer (stack of negative C plates) having a thickness direction retardation Rth of 200 nm was obtained.

### <Second Polarizer>

The second polarizer used was one obtained by dyeing a polyvinyl alcohol film with an iodine complex (or dye) to adsorb the iodine complex on the polyvinyl alcohol film, and stretching the film for alignment (absorptive polarizer).

### Example 8

A liquid crystal display device of Example 8 was the same as the liquid crystal display device of Example 7, except that the specifications of the first retardation layer were different.

### <First Retardation Layer>

The first retardation layer used was one formed by the following method. A stretched cycloolefin polymer film (negative C plate) was formed by the method described with reference to FIGS. 2A and 2B. The specifications thereof were as follows.
Thickness D: 50000 nm
Principal refractive index nx: 1.5015
Principal refractive index ny: 1.5015
Principal refractive index nz: 1.496
Thickness direction retardation Rth: 275 nm

Two of these films were obtained, and the films were stacked with a colorless and transparent adhesive film having a three-dimensionally isotropic refractive index (1.47) in between. Thereby, a retardation layer (stack of negative C plates) having a thickness direction retardation Rth of 550 nm was obtained.

### Example 9

A liquid crystal display device of Example 9 was the same as the liquid crystal display device of Example 7, except that the specifications of the first retardation layer were different.

### <First Retardation Layer>

The first retardation layer used was one formed by the following method. A stretched cycloolefin polymer film (negative C plate) was formed by the method described with reference to FIGS. 2A and 2B. The specifications thereof were as follows.
Thickness D: 50000 nm
Principal refractive index nx: 1.501
Principal refractive index ny: 1.501
Principal refractive index nz: 1.496
Thickness direction retardation Rth: 250 nm

Four of these films were obtained, and the films were stacked with a colorless and transparent adhesive film having a three-dimensionally isotropic refractive index (1.47) in between. Thereby, a retardation layer (stack of negative C plates) having a thickness direction retardation Rth of 1000 nm was obtained.

### Comparative Example 5

A liquid crystal display device of Comparative Example 5 was the same as the liquid crystal display device of Example 7, except that the specifications of the first retardation layer were different.

### <First Retardation Layer>

The first retardation layer used was a stretched cycloolefin polymer film (negative C plate) formed by the method described with reference to FIGS. 2A and 2B. The specifications thereof were as follows.
Thickness D: 20000 nm
Principal refractive index nx: 1.501
Principal refractive index ny: 1.501
Principal refractive index nz: 1.496
Thickness direction retardation Rth: 100 nm

### Comparative Example 6

A liquid crystal display device of Comparative Example 6 was the same as the liquid crystal display device of Example 7, except that the specifications of the first retardation layer were different.

### <First Retardation Layer>

The first retardation layer used was one formed by the following method. A stretched cycloolefin polymer film (negative C plate) was formed by the method described with reference to FIGS. 2A and 2B. The specifications thereof were as follows.
Thickness D: 50000 nm
Principal refractive index nx: 1.5015
Principal refractive index ny: 1.5015
Principal refractive index nz: 1.496
Thickness direction retardation Rth: 275 nm

Four of these films were obtained, and the films were stacked with a colorless and transparent adhesive film having a three-dimensionally isotropic refractive index (1.47) in between. Thereby, a retardation layer (stack of negative C plates) having a thickness direction retardation Rth of 1100 nm was obtained.

### [Evaluation 3]

The viewing angle characteristics of each of the liquid crystal display devices of Examples 7 to 9 and Comparative Examples 5 and 6 were evaluated by calculating the front contrast ratio and the oblique contrast ratio in the same manner as in Evaluation 1. The results are shown in Table 3.

TABLE 3

| | Thickness direction | | |
|---|---|---|---|
| | retardation Rth of first | Front contrast | Oblique contrast |
| | retardation layer (nm) | ratio | ratio |
| Example 7 | 200 | 791 | 13 |
| Example 8 | 550 | 301 | 2 |
| Example 9 | 1000 | 114 | 12 |
| Comparative | 100 | 981 | 35 |
| Example 5 | | | |
| Comparative | 1100 | 96 | 13 |
| Example 6 | | | |

Table 3 shows that transverse electric field mode liquid crystal display devices having a narrow viewing angle were obtained in Examples 7 to 9. In Comparative Example 5, however, the oblique contrast ratio was higher than 20, and thus the visibility from an oblique direction was unfortunately high. In Comparative Example 6, the front contrast ratio was lower than 100, and thus the visibility from the front direction was unfortunately low.

### Example 10

The liquid crystal display device of Embodiment 4 was produced as a liquid crystal display device of Example 10. The liquid crystal display device of Example 10 included the following members. The first polarizer and the first substrate were bonded to each other with a transparent adhesive. The second substrate and the second retardation layer were bonded to each other with a transparent adhesive. The second retardation layer and the second polarizer were bonded to each other with a transparent adhesive.

### <First Polarizer>

The first polarizer used was one obtained by dyeing a polyvinyl alcohol film with an iodine complex (or dye) to adsorb the iodine complex on the polyvinyl alcohol film, and stretching the film for alignment (absorptive polarizer).

### <First Substrate>

The first substrate used was one (thin-film transistor array substrate) obtained by disposing an electrode structure for the IPS mode on a surface of a glass substrate.

### <Liquid Crystal Layer>

The liquid crystal layer used was one containing a positive liquid crystal material (anisotropy of dielectric constant Δε: 2.5). The specifications thereof were as follows.
Thickness d: 3000 nm
Refractive index anisotropy Δn: 0.11
Retardation: 330 nm

### <Second Substrate>

The second substrate used was one (color filter substrate) obtained by disposing a color filter structure for the IPS mode on a surface of a glass substrate.

### <Second Retardation Layer>

The second retardation layer used was a film (positive C plate) formed by the method described with reference to FIGS. 5A, 5B, and 5C. The specifications thereof were as follows.
Thickness D: 5000 nm
Principal refractive index nx: 1.49
Principal refractive index ny: 1.49
Principal refractive index nz: 1.53
Thickness direction retardation Rth: −200 nm

### <Second Polarizer>

The second polarizer used was one obtained by dyeing a polyvinyl alcohol film with an iodine complex (or dye) to adsorb the iodine complex on the polyvinyl alcohol film, and stretching the film for alignment (absorptive polarizer).

### Example 11

A liquid crystal display device of Example 11 was the same as the liquid crystal display device of Example 10, except that the specifications of the second retardation layer were different.

### <Second Retardation Layer>

The second retardation layer used was one formed by the following method. A film (positive C plate) was formed by the method described with reference to FIGS. 5A, 5B, and 5C. The specifications thereof were as follows.
Thickness D: 5000 nm
Principal refractive index nx: 1.49
Principal refractive index ny: 1.49
Principal refractive index nz: 1.545
Thickness direction retardation Rth: −275 nm

Two of these films were obtained, and the films were stacked with a colorless and transparent adhesive film having a three-dimensionally isotropic refractive index (1.47) in between. Thereby, a retardation layer (stack of positive C plates) having a thickness direction retardation Rth of −550 nm was obtained.

### Example 12

A liquid crystal display device of Example 12 was the same as the liquid crystal display device of Example 10, except that the specifications of the second retardation layer were different.

### <Second Retardation Layer>

The second retardation layer used was one formed by the following method. A film (positive C plate) was formed by the method described with reference to FIGS. 5A, 5B, and 5C. The specifications thereof were as follows.
Thickness D: 5000 nm
Principal refractive index nx: 1.49
Principal refractive index ny: 1.49
Principal refractive index nz: 1.545
Thickness direction retardation Rth: −275 nm

Four of these films were obtained, and the films were stacked with a colorless and transparent adhesive film having a three-dimensionally isotropic refractive index (1.47) in between. Thereby, a retardation layer (stack of positive C plates) having a thickness direction retardation Rth of −1100 nm was obtained.

### Comparative Example 7

A liquid crystal display device of Comparative Example 7 was the same as the liquid crystal display device of Example 10, except that the specifications of the second retardation layer were different.

### <Second Retardation Layer>

The second retardation layer used was a film (positive C plate) formed by the method described with reference to FIGS. 5A, 5B, and 5C. The specifications thereof were as follows.
Thickness D: 2500 nm
Principal refractive index nx: 1.49
Principal refractive index ny: 1.49
Principal refractive index nz: 1.53
Thickness direction retardation Rth: −100 nm

### Comparative Example 8

A liquid crystal display device of Comparative Example 8 was the same as the liquid crystal display device of Example 10, except that the specifications of the second retardation layer were different.

### <Second Retardation Layer>

The second retardation layer used was one formed by the following method. A film (positive C plate) was formed by the method described with reference to FIGS. 5A, 5B, and 5C. The specifications thereof were as follows.
Thickness D: 5000 nm
Principal refractive index nx: 1.49
Principal refractive index ny: 1.49
Principal refractive index nz: 1.53
Thickness direction retardation Rth: −200 nm

Six of these films were obtained, and the films were stacked with a colorless and transparent adhesive film having a three-dimensionally isotropic refractive index (1.47) in between. Thereby, a retardation layer (stack of positive C plates) having a thickness direction retardation Rth of −1200 nm was obtained.

### [Evaluation 4]

The viewing angle characteristics of each of the liquid crystal display devices of Examples 10 to 12 and Comparative Examples 7 and 8 were evaluated by calculating the front contrast ratio and the oblique contrast ratio in the same manner as in Evaluation 1. The results are shown in Table 4.

TABLE 4

| | Thickness direction | Front | |
|---|---|---|---|
| | retardation Rth of second | contrast | Oblique contrast |
| | retardation layer (nm) | ratio | ratio |
| Example 10 | −200 | 833 | 18 |
| Example 11 | −550 | 318 | 3 |
| Example 12 | −1100 | 100 | 14 |
| Comparative | −100 | 1012 | 46 |
| Example 7 | | | |
| Comparative | −1200 | 85 | 16 |
| Example 8 | | | |

Table 4 shows that transverse electric field mode liquid crystal display devices having a narrow viewing angle were obtained in Examples 10 to 12. In Comparative Example 7, however, the oblique contrast ratio was higher than 20, and thus the visibility from an oblique direction was unfortunately high. In Comparative Example 8, the front contrast ratio was lower than 100, and thus the visibility from the front direction was unfortunately low.

### SUMMARY

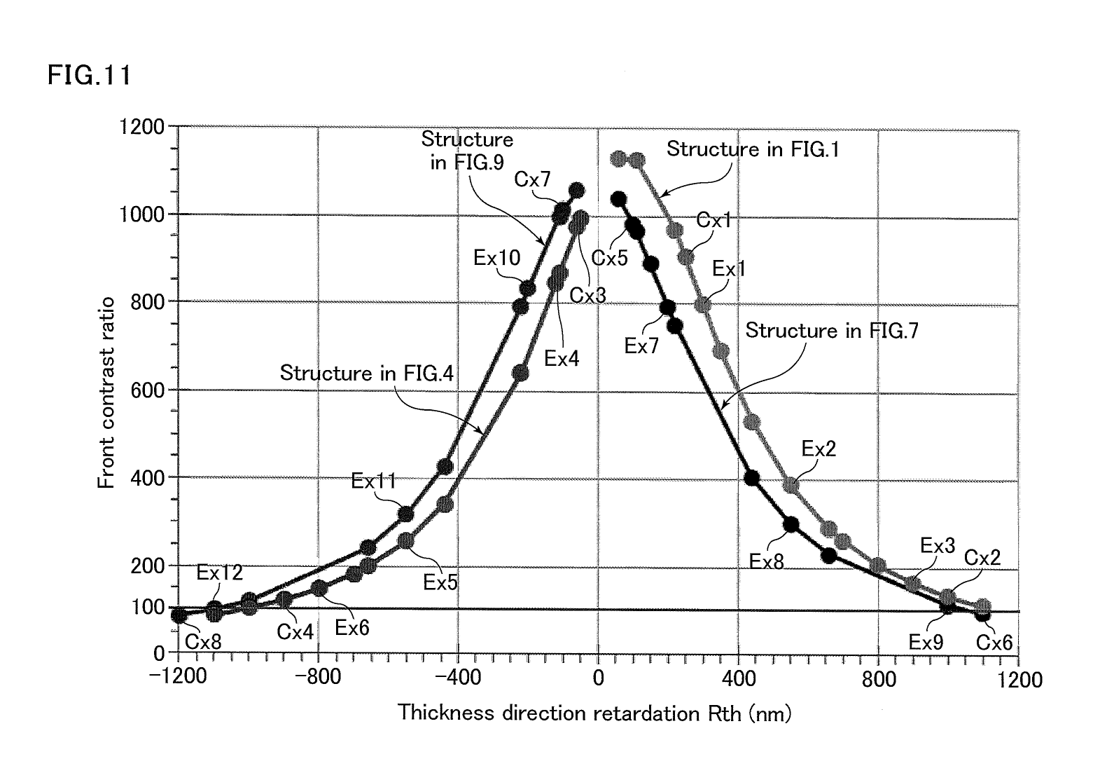

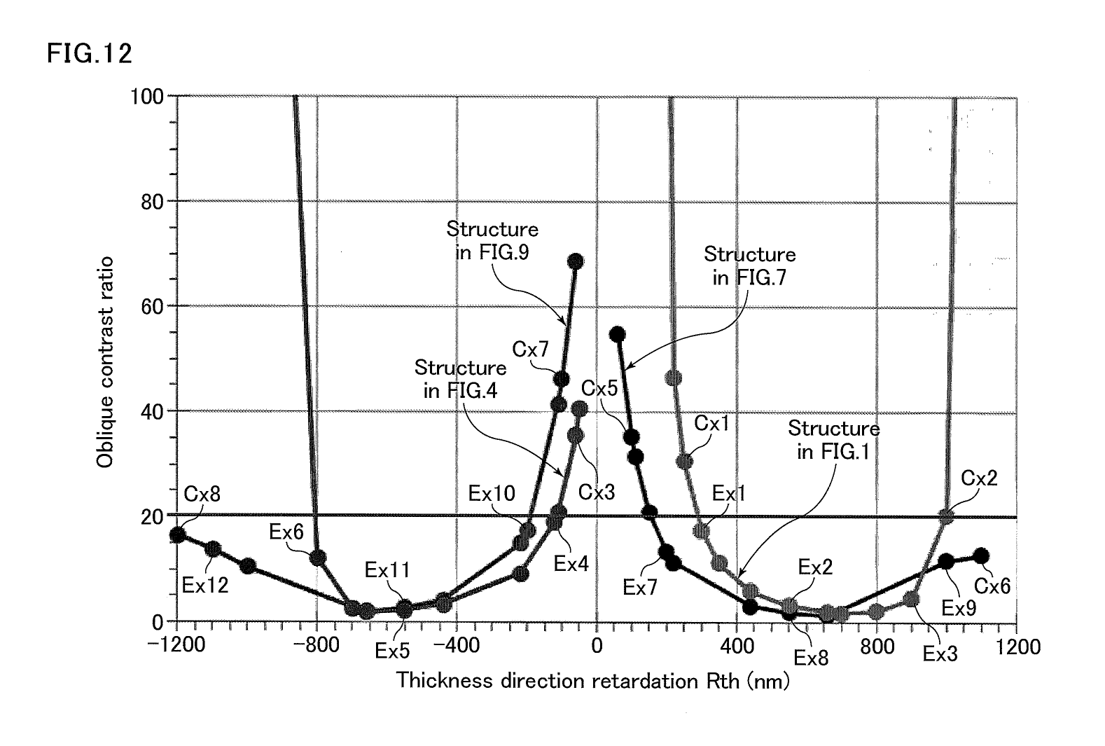

In Evaluations 1 to 4, the viewing angle characteristics (front contrast ratio and oblique contrast ratio) of the representative examples of the structures shown in FIGS. 1, 4, 7, and 9 were evaluated. Given the results obtained by varying the thickness direction retardation Rth of each of the first retardation layer and the second retardation layer within the range out of the range defined in each of the above representative examples, each liquid crystal display device exhibited the behavior as shown in FIGS. 11 and 12. FIG. 11 is a graph showing the relationship between the thickness direction retardation Rth and the front contrast ratio in the first retardation layer and the second retardation layer. FIG. 12 is a graph showing the relationship between the thickness direction retardation Rth and the oblique contrast ratio in the first retardation layer and the second retardation layer. In FIGS. 11 and 12, the reference signs Ex1 to Ex12 mean Examples 1 to 12, respectively, and the reference signs Cx1 to Cx8 mean Comparative Examples 1 to 8, respectively.

FIGS. 11 and 12 show that with each of the structures shown in FIGS. 1, 4, 7, and 9, a transverse electric field mode liquid crystal display device having a narrow viewing angle can be achieved as long as the thickness direction retardation Rth of the first retardation layer or the second retardation layer falls within the following range.

(Structure in FIG. 1) Thickness direction retardation Rth of first retardation layer: 300 to 900 nm
(Structure in FIG. 4) Thickness direction retardation Rth of second retardation layer: −800 to −120 nm
(Structure in FIG. 7) Thickness direction retardation Rth of first retardation layer: 200 to 1000 nm
(Structure in FIG. 9) Thickness direction retardation Rth of second retardation layer: −1100 to −200 nm

Also with each of the structures shown in FIGS. 3, 6, 8, and 10, which are modified examples of the structures shown in FIGS. 1, 4, 7, and 9, respectively, a transverse electric field mode liquid crystal display device having a narrow viewing angle can be achieved as long as the thickness direction retardation Rth of the first retardation layer or the second retardation layer falls within the above range.

### [Additional Remarks]

One aspect of the present invention may be a liquid crystal display device including, in the following order from a back surface side to a viewing surface side: a first polarizer; a liquid crystal layer containing liquid crystal molecules; and a second polarizer, the liquid crystal display device being in a transverse electric field mode, the liquid crystal molecules being aligned in a plane parallel to surfaces of the first polarizer and the second polarizer, the first polarizer and the second polarizer being disposed such that their absorption axes are perpendicular to each other, the liquid crystal display device including at least one first retardation layer whose principal refractive indexes satisfy a relationship nx=ny>nz or at least one second retardation layer whose principal refractive indexes satisfy a relationship nx=ny<nz between the first polarizer and the liquid crystal layer or between the second polarizer and the liquid crystal layer, the at least one first retardation layer and the at least one second retardation layer satisfying: (1) a relationship where the at least one first retardation layer, in the case of being disposed between the first polarizer and the liquid crystal layer, has a total thickness direction retardation Rth of 300 to 900 nm; (2) a relationship where the at least one second retardation layer, in the case of being disposed between the first polarizer and the liquid crystal layer, has a total thickness direction retardation Rth of −800 to −120 nm; (3) a relationship where the at least one first retardation layer, in the case of being disposed between the second polarizer and the liquid crystal layer, has a total thickness direction retardation Rth of 200 to 1000 nm; or (4) a relationship where the at least one second retardation layer, in the case of being disposed between the second polarizer and the liquid crystal layer, has a total thickness direction retardation Rth of −1100 to −200 nm, wherein, in the at least one first retardation layer and the at least one second retardation layer, nx and ny each represent a principal refractive index in an in-plane direction, nz represents a principal refractive index in a thickness direction, and a thickness direction retardation Rth equals to ((nx+ny)/2−nz)×D, where D represents a thickness. This aspect achieves a transverse electric field mode liquid crystal display device having a narrow viewing angle.

A first substrate may be disposed between the first polarizer and the liquid crystal layer, a second substrate may be disposed between the second polarizer and the liquid crystal layer, and the at least one first retardation layer or the at least one second retardation layer may be disposed between the first polarizer and the first substrate or between the second polarizer and the second substrate. This enables the at least one first retardation layer or the at least one second retardation layer to be an out-cell member.

The transverse electric field mode may be an IPS mode. This achieves an IPS mode liquid crystal display device having a narrow viewing angle.

What is claimed is:

1. A liquid crystal display device comprising, in the following order from a back surface side to a viewing surface side:
a first polarizer;
a liquid crystal layer containing liquid crystal molecules; and
a second polarizer,
the liquid crystal display device being in a transverse electric field mode,
the liquid crystal molecules being aligned in a plane parallel to surfaces of the first polarizer and the second polarizer,
the first polarizer and the second polarizer being disposed such that their absorption axes are perpendicular to each other,
the liquid crystal display device including at least one first retardation layer whose principal refractive indexes satisfy a relationship nx=ny>nz or at least one second retardation layer whose principal refractive indexes satisfy a relationship nx=ny<nz between the first polarizer and the liquid crystal layer or between the second polarizer and the liquid crystal layer,
the at least one first retardation layer and the at least one second retardation layer satisfying:
(1) a relationship where the at least one first retardation layer, in the case of being disposed between the first polarizer and the liquid crystal layer, has a total thickness direction retardation Rth of 300 to 900 nm;
(2) a relationship where the at least one second retardation layer, in the case of being disposed between the first polarizer and the liquid crystal layer, has a total thickness direction retardation Rth of −800 to −120 nm;
(3) a relationship where the at least one first retardation layer, in the case of being disposed between the second polarizer and the liquid crystal layer, has a total thickness direction retardation Rth of 200 to 1000 nm; or
(4) a relationship where the at least one second retardation layer, in the case of being disposed between the second polarizer and the liquid crystal layer, has a total thickness direction retardation Rth of −1100 to −200 nm,
wherein, in the at least one first retardation layer and the at least one second retardation layer, nx and ny each represent a principal refractive index in an in-plane direction, nz represents a principal refractive index in a thickness direction, and a thickness direction retardation Rth equals to ((nx+ny)/2−nz)×D, where D represents a thickness.

2. The liquid crystal display device according to claim 1,
wherein a first substrate is disposed between the first polarizer and the liquid crystal layer,
a second substrate is disposed between the second polarizer and the liquid crystal layer, and
the at least one first retardation layer or the at least one second retardation layer is disposed between the first polarizer and the first substrate or between the second polarizer and the second substrate.

3. The liquid crystal display device according to claim 1,
wherein the transverse electric field mode is an IPS mode.
